(19) United States
(12) Patent Application Publication
(10) Pub. No.: US 2010/0102929 A1
(43) Pub. Date: Apr. 29, 2010

(54) PROTECTION, SECURITY AND DISPLACEMENT TRACKING LUMINOUS BADGE SYSTEM

(76) Inventor: Philippe Haumann, Modave (BE)

Correspondence Address: BAKER & DANIELS LLP, 300 NORTH MERIDIAN STREET, SUITE 2700, INDIANAPOLIS, IN, 46204, US

(21) Appl. No.: 12/514,003

(22) PCT Filed: Nov. 9, 2007
(86) PCT No.: PCT/BE07/00118

§ 371 Date: May 7, 2009

(30) Foreign Application Priority Data
Nov. 9, 2006 (BE) 2006/0538

(51) Int. Cl. G06F 7/04; H04Q 5/22

(52) U.S. Cl. 340/5.81; 340/10.51

(57) ABSTRACT

The invention relates to an equipment comprising at least one badge (40) provided with a power source (41), at least one energy radiation source (42) and an actuation member (43) for said source connected to a computer memory (45), an energy wave receiver (46), an actuation member programming unit (91), an interface (92) between the programming unit (91) and the memory, and a beacon (21), characterised in that the badge is capable of displacement and in that the above-mentioned actuation member and its memory are driven according to a predetermined space position of the badge and/or a command received from the interface and/or the beacon.

### FIELD OF THE INVENTION

The invention relates to installations intended to protect, control, secure, monitor objects, goods, equipment, animals or people both indoors and outdoors or, even, to track their displacements.

### STATE OF THE ART

There are numerous systems that relate to the surveillance, protection, security or traceability of goods and people. Among others, there are portals, doors or airlocks for controlling passage based on the reading of magnetic badges, badges with electronic chip, RFID “tags”, biometric characteristics (fingerprint, iris characteristics, etc.) or on the detection of magnetic loop tags. In another type of control, there are also intrusion detectors (based on contacts, vibration, acceleration, etc.), motion detectors, presence or absence detectors (infrared, ultrasound, radar wave, etc.) and, finally, bracelets for control of people being monitored.

All these systems are based either on the detection of a presence or an absence of beings or of objects in predetermined spaces and/or rooms, fixed and delimited, or on control at fixed points (points of passage, enclosure entries and exits, etc.). Furthermore, for the most part, they require centralized surveillance or security management in the form of a central alarm unit or a surveillance and/or security control room.

Although the applications based on the use of GPS are not limited to fixed points, they do suffer, however, on the one hand, from the use of satellites, that is, an infrastructure that is not controlled by the user, and on the other hand, from the fact that they do not function inside buildings and, finally, that they are high energy consumers and therefore they are difficult to miniaturize given the necessary capacity of the energy source that feeds them.

Obviously, inventions devoted to location or security avoid the use of an external infrastructure. Thus, the patent US 2006/0013070 describes a refined installation based on a proprietary infrastructure that uses ultrasound and radio waves. However, despite its performance characteristics, this invention is expensive to implement and suffers from a lack of functionalities on the mobile device with which the objects or people are provided. Furthermore, the elements that it comprises do not have the multipurpose nature of those of the invention described hereinafter in this document.

### SUMMARY OF THE INVENTION

The aim of the invention is now to remedy the limited or restrictive performance characteristics of the existing surveillance, security or tracking systems, some of which are described above, by providing a novel installation that overcomes, among other things, the drawbacks of the fixed access controls and the limitations of the systems based on the simple detection of presence or absence in predetermined, fixed and delimited spaces and/or premises, and even the need for centralized management or the requirement to make use of an infrastructure not controlled by the user. In practice, this novel installation, which functions both indoors and outdoors, enables any individual, animal or surveillance device to verify at any moment, at any point of the place covered by the invention and in a simple manner, if a person, an animal or an object is allowed to be present or must not be present or, even, is allowed to be present but subject to conditions, at any point of the place being monitored. The invention also provides for signaling if the person, the animal or the object leaves the control perimeter of the place covered by the invention.

The invention also provides a solution to a major concern of the times, namely the protection, in the safeguarding sense, of people and goods, for example, in signaling hazardous places to them. It therefore makes it possible to achieve two main objectives: the safety, surveillance and tracking of displacements of objects, of equipment, of goods, of animals and of people, but also the protection (safeguarding) of these same objects, equipment, goods, animals and people with respect to the place or the environment where they are located.

The invention is based on a simple principle: the person, the animal, the item, the equipment or the object to be monitored is provided with a device capable of being positioned in space that signals by the transmission of one or more effects, for example, the illumination of a light source and/or the transmission of a sound signal—an exemplary and non-exhaustive list—the authorization given to the object, the item, the equipment, the animal or the person wearing it. The effect or the effects transmitted can be perceived not only by the actual wearer of said device but also by other people, animals or living beings, present in the place and by machines including those designed to monitor the places (cameras, sensors, detectors, etc.), enabling the latter to confirm immediately and in an evident manner the authorization or the restrictions on authorization to which the object, the equipment, the item, the animal or the person is subject in the place, regardless of the point (and not limited to control points) provided that it is situated in the enclosure covered by the invention.

The physical and technical embodiment of the invention can be executed in a number of ways depending on the degree of refinement and sophistication of its installation.

Consequently, the invention relates to a surveillance installation comprising:
at least one badge capable of displacement, provided with at least one energy radiation source and an actuation member for said source, provided with a memory;
at least one actuation member programming unit; and
an interface between the programming unit and the actuation member memory, for transferring an operating program from said programming unit to said actuation member memory,
   said interface comprising
at least one beacon;
at least one sender of energy waves to the beacon; and
at least one receiver of said energy waves, supported by the badge; and
   the abovementioned actuation member and its memory being driven by
a space position of the badge relative to the beacon, said space position being calculated at any instant by the operating program in response to messages sent by the beacon.

In the inventive installation, we use the term “badge” to mean both a badge in the proper sense of the term as worn by a person, an animal or an object, and an object of any kind, form and size—the kind, the forms and the dimensions of the object not being critical to the invention—that can be applied to goods, an item of equipment, an object, an animal, a person, a package, a support, an attachment or even a part or a clothing accessory. In certain cases, the badge can be incorporated in these same objects or living beings. For the physical embodiment of the invention, efforts have obviously been made to minimize the volume of the device contained in the badge and its energy consumption when in operation, when paused and when idle.

The expression “energy radiation source” generally designates any means capable of generating work. It notably includes acoustic radiation sources, electromagnetic radiation sources, radioactive sources, hydraulic energy sources and heat energy sources, as well as mechanical or electrical members capable of generating an instruction to drive a mechanism present on the badge or outside the latter to which it is linked physically or by a wireless communication means (exemplary and non-exhaustive list).

The expression “wireless communication” designates any means of transferring signals or data without the use of a mechanical or physical connection by wires, cables or similar. This means of communication is, for the most part, based on the transmission of an energy wave such as acoustic or electromagnetic waves. The definition of a link by energy wave given hereinbelow can also be applied to the expression “wireless communication”.

According to the invention, preference is given to selecting the energy radiation source from acoustic radiation sources and electromagnetic radiation sources. In the case of an acoustic radiation source, the latter can be an ultrasound source, when the badge is intended to be identified by a receiver sensitive to ultrasound or by an animal sensitive to ultrasound (for example, a dog trained to react to ultrasounds). Preference is generally given to the use of a sound source in the range of frequencies audible to the human ear. In the case of an electromagnetic radiation source, the latter is advantageously a light source. It can be a monochromatic or polychromatic light source or a laser beam. Sources of non-visible radiation (for example, in the infrared or ultraviolet spectra) fall within the context of the invention. As a general rule, according to the invention, preference is given to the selection of energy radiation sources from those that can provoke an effect that can be perceived by living beings but also by any detectors or machines including those designed for the counting, tracking or even monitoring and/or security of places. These effects can be transmitted by the badge itself or by a “peripheral device”, namely any element driven by said badge and connected thereto physically or by means of a wireless communication technique and provided with one or more energy radiation sources. In order to simplify the text, we will we use the term “wearer” to designate the objects, equipment, goods, packages, supports, attachments, parts or clothing accessories, animals and people equipped with the abovementioned badge as defined hereinabove. The expression “badge capable of displacement” denotes a physical object, the position of which is subject to programmed or random variations. The rapidity of these variations is not critical to the invention.

The function of the actuation member is to activate the energy radiation source or sources. It comprises a memory and is generally multifunctional, which means that it is designed to act on one or more parameters of the energy radiation source or, sources, according to a predetermined operating program, contained in its memory. In the particular case of an acoustic or electromagnetic radiation source, these parameters comprise the activation, the frequency and the intensity of the radiation source. A simplified explanatory example of an operating program comprises the illumination of a light source when the badge is located in a place where it is not allowed to be present. Detailed examples of predefined programs will be explained later.

The function of the programming unit is to create the abovementioned operating program and to communicate it to the memory of the actuation member. The creation of the operating program is normally performed by an operator. The operating program can be created by combining a series of diverse instructions. It is also possible, according to a particular embodiment of the invention, to select the operating program at the outset from several programs preestablished and prestored in the programming unit. To this end, in a preferred embodiment of the inventive installation, the programming unit contains several prestored programs and a device for selecting, as required, one of these prestored programs which is then the abovementioned operating program. Hereinafter, the expression “operating program” will designate the program that is located in the memory of the actuation member of the energy radiation source of the badge and that drives the operation of this actuation member. The expression “preestablished program” will designate a program created by an operator (an individual or a group of individuals) and the expression “prestored program” will designate a preestablished program, stored in the programming unit. The programming unit can be capable of displacement or fixed, the term “capable of displacement” having the same definition as that provided above for the definitions of the badge capable of displacement. As explained above, the memory of the actuation member of the energy radiation source or sources of the badge capable of displacement contains an operating program. This operating program drives the actuation member of said energy radiation source or sources and therefore enables the badge to react autonomously. It has been created in the programming unit by an assembly of instructions (preestablished program) or it has been selected from a list of programs previously stored in the programming unit (prestored program). The operating program and, where appropriate, the prestored programs then contain a series of instructions that depend on the badge capable of displacement itself, on its destination and on its function, on the installation in which it will be used, and also on the wearer for which it is intended. Take as an example the authorizations granted to its wearer, the location computation frequency which can range from several times a second to a periodicity of several days, months or even years, the keys and the method of encrypting the messages that it receives and, where appropriate, that it could send, but also the assignment of a unique identifier in the installation which may or may not be related to a possible unique identifier which would have been fixed when it was manufactured or, in any case, before it was made available on the market. As an example, the badge of the CEO of a company will enable him to go to any point in the company while warning him of places that present a real hazard to himself. On the other hand, the badge of a maintenance subcontractor will signal wherever he is not authorized to be in these places but not in the places to which he must go to perform his job (all or part of certain corridors, manufacturing shop floors, manufacturing shop floor control rooms, amenities, etc.). In the same spirit, the operating program of the badge can contain information specific to the wearer of the badge to provide a response to an aspect of practical life, for example, within a company, by qualifying its wearer by means of a light signal emitted by the badge (or a peripheral device controlled by the latter) with a specific color to distinguish people who are part of the personnel of the company occupying the places, from outside people required to carry out specific subcontract work and visitors.

The function of the interface is to transfer the abovementioned operating program from the programming unit to the memory of the actuation member for the badge capable of displacement. Another of its functions is to transfer their parameters to the beacons, the definition of which will be given below. The interface can be capable of displacement or fixed, the term “capable of displacement” having the same definition as that provided above, for the definition of the badge capable of displacement. Moreover, the interface can be linked removably or non-removably to the programming unit. In the case of a non-removable link, the programming unit can be an integral part of the interface. It is, however, preferable, according to a variant of the invention, for the programming unit to be separate from the interface and for it to be linked thereto removably, to be able to be separated therefrom. Any appropriate interface for transferring signals containing data or instructions can be used, within the context of the invention. The selection of the most appropriate interface will depend on the badge capable of displacement and on the programming unit and it may differ depending on whether the programming unit is capable of displacement or fixed, depending on whether the interface is capable of displacement or fixed and depending on whether the interface is linked removably or non-removably to the programming unit.

The function of the beacon is to periodically send an energy wave which will be picked up by the energy wave receiver of the badge capable of displacement. To this end, it is provided with a clock which will establish the pacing of the transmission of the energy wave and a memory that will contain a certain number of parameters such as the periodicity of transmission, the power at which it transmits, its unique identifier within the installation, the keys and method of encryption used in the messages and data that will be transmitted in the signal that it transmits. The energy wave transmitted by the beacon will contain data which, among other things, will enable the badge to identify the beacon and compute its position relative to the beacon. The operating program of the badge may take account of this positioning data to act on the actuation member of the radiation source in accordance with the instructions contained in the memory. The power supply for the beacon can be produced by any external electrical energy source, including the mains distribution network. However, preference will also be given to equipping the beacon with an autonomous energy source, a battery or a cell, for example, which will continue to power the beacon should the external electrical energy source fail. In this way, all of the installation will remain functional even in such circumstances. In a variant of the invention, provision is made for the beacon to transmit its energy wave signal on a command obtained, for example, from the programming unit or from the interface.

The function of the programming unit is also to adjust the parameters of the or each beacon, including the transmission power of the beacon since the latter can be adjusted—in real time or offline—the unique identifier bf the beacon within the installation which may or may not be related to any unique identifier which would have been fixed when it was manufactured or, in any case, before it was placed on the market, the encryption key or keys and the method of encrypting the messages that it transmits or, where appropriate, might receive (exemplary and non-exhaustive list).

According to the invention, a “link by energy waves” consists of a transmission of energy which is essentially performed without the intervention of a physical connection by wires, cables or similar. The energy waves producing this communication can comprise sound waves. They preferably comprise electromagnetic waves, especially radiofrequency waves of the type of those commonly used in radio links. VHF and UHF waves are ideal. Links by laser beams can also be used.

An exemplary and noteworthy characteristic of the invention already emerges following these definitions, namely that the badge capable of displacement is active and autonomous in its behavior. This exemplary and noteworthy characteristic enables the invention to offer functions that are not possible when the object or the being capable of displacement is equipped with a passive device and/or one without any intelligence functionality and/or artificial logic.

In an advantageous embodiment of the invention, it is possible to add a spatialization table and/or a topography table to the operating program. The spatialization table comprises a series of parameters that are activated selectively to drive the actuation member of the badge capable of displacement, in response to the instructions transmitted by the beacon and relating to the space coordinates of the badge capable of displacement. Under the effect of this driving, the energy radiation source or sources will produce work defined by the actuation member, according to the relative space coordinates of said badge capable of displacement. The topography table comprises a series of parameters that are activated selectively to drive the actuation member of the badge capable of displacement, in response to the instructions transmitted by the beacon and relating to information related to the topography of the places, such as different levels or floors of a building or obstacles to the normal propagation of the energy waves. These obstacles can, for example, comprise walls, staircases, inclined planes, suspended ceilings, energy radiation sources, statues or other decorations, plant pots, metal masses, water tanks, fountains, etc. For example, in the case where the energy radiation source of the badge capable of displacement comprises an acoustic or electromagnetic radiation source, the abovementioned driving will act on the frequency and/or the intensity of the acoustic or electromagnetic source according to the space coordinates of the badge capable of displacement (in the case of a spatialization table) and/or according to the presence of a predefined obstacle in the vicinity of the badge capable of displacement (in the case of a topography table).

In an especially advantageous embodiment of the invention, the interface will be equipped with a transmitter of energy waves which can be picked up by the energy wave receiver of the badge. The transfer of the operating program from the programming unit to the memory of the actuation member of the badge capable of displacement can then be performed by means of this non-physical link. This embodiment of the invention offers the particular feature of making it possible to maintain a link between the programming unit and the memory of the badge capable of displacement, even in the case where the badge and/or the programming unit and/or the interface is displaced. This makes it possible to modify permanently and at will the operating program included in the memory of the badge capable of displacement.

In an additional form of execution of the especially advantageous embodiment described above, the installation also comprises a control device, designed to transfer via the interface and/or the beacons one-off instructions to the actuation member of the badge capable of displacement in addition to those in its memory or after short circuiting the latter. This embodiment of the invention means that the or each beacon and/or the interface comprise(s) energy wave transmitters. In this additional form of execution of the invention, the installation allows for cooperation of said control device with a specific badge capable of displacement defined by a serial number for transferring instructions to this badge capable of displacement and sending to the latter specific instructions, to adapt the function of the actuation member of the energy radiation source or sources according to various circumstances that could not have been preprogrammed such as, for example, the space or geographical position of the badge capable of displacement, the appearance of an unexpected or particular phenomenon, the occurrence of local or chance information, a variation of the pressure or ambient temperature, or of the ambient lighting (exemplary and non-exhaustive list). A practical example of the use of this characteristic of the invention can be evoked when searching for a small object in amongst a multitude of objects. This case arises frequently in the grouping, allocation and dispatching areas of distribution companies. When this occurs, it is possible to use the abovementioned control device to send to the badge of the object concerned the order to transmit at low power (so as not to clutter the frequency bands and/or disrupt a part of the installation) and at very short intervals, a specific identification message. To further enhance the aid to the search, it is possible, for example, to have the badge transmit a blinking light ray. By being equipped with a receiver that will pick up said specific message, it becomes easily and quickly possible to specify the point where the object being sought is located and identify the latter by the blinking light signal that it is transmitting. Once the latter is found, said control device can be asked to send to the badge of the found object the order to revert to its normal operating mode according to the operating program active in the memory of its actuation device.

In a preferred variant of the additional form of execution of the especially advantageous embodiment described hereinabove, the abovementioned control device can be incorporated in the programming unit.

In a particularly advantageous execution variant of the invention, the functions of the interface can be assumed (in whole or in part) by the or each beacon. In this way, these functions are grouped together in a single element of the installation. In this case, the interface will advantageously use the energy wave transmitter of the beacon to transfer the operating programs to the badge capable of displacement. In the particularly advantageous execution variant of the invention described hereinabove, it is therefore possible, at any instant, to replace the active operating program of the badge capable of displacement with another operating program. Similarly, this will make it possible to send a direct command to the badge capable of displacement which, as appropriate, can take priority over the operating program.

In an additional embodiment of the particularly advantageous execution variant of the invention mentioned hereinabove, the link between the programming unit and the or each beacon and/or interface that is fixed can be produced physically. This physical link makes it possible not only to transfer data but also to top up these elements with energy. This additional embodiment of the invention also makes it possible to modify at any moment the parameters of the or each beacon. In a simplified version of this additional form of execution of the invention, provision is made for the or each beacon to be limited to a single standardized transmitter that relays a signal created in real time by the programming unit to which it is linked. In this case, the or each beacon is no longer provided with a battery, a memory or a clock, unless the degree of reliability and the operating warranty of the installation demands that the or each beacon remain operational even if the physical link with the programming unit is broken.

In another additional particularly advantageous execution variant of the invention, the badge capable of displacement can, if necessary, comprise a transmitter of energy waves and the or each beacon and/or the interface can, if necessary, comprise an energy wave receiver. In this variant embodiment of the invention, the transceiver of the badge capable of displacement and the transceiver of the beacon and/or of the interface can dialog in such a way that the abovementioned actuation member, of the badge capable of displacement reacts to signals from the beacon, said signals being driven initially by information transferred by the transmitter of the badge capable of displacement to the receiver of the beacon and/or of the interface. Similarly, the beacon and/or the interface can communicate the information transmitted by the badge to a processing unit (99) to be stored therein for various purposes including, for example, the establishment of the statistics or the history of the displacements of the badges capable of displacement and/or analyzed, for example, to modify the signals transmitted by the beacon.

The term “processing unit” is used to designate an appliance capable of memorizing data and of performing mathematical or logical operations and executing prestored instructions (computer programs) by using this data. This appliance will advantageously be equipped with the necessary interfaces for communicating with the other people and also with other machines. A microcomputer will be ideal for handling the functions required of the processing unit.

In the inventive installation, the badge capable of displacement can, if necessary, comprise one or more sensors, the technical function of which is to enable the abovementioned operating program, stored in its memory, to react autonomously to the actuation member of the energy radiation source or sources of the badge capable of displacement, in response to local parameters (for example, the light intensity of the places, a modification of this light intensity, a modification of the temperature of the environment or, in the case of a badge proper, of a physiological parameter of its wearer). As a variant, the operating program can be designed to transfer these local parameters for the beacons and/or to the interface, so as to be able to receive particular driving instructions from the actuation member of the energy radiation source of the badge capable of displacement. As has been stated above, these parameters can advantageously be transmitted to the processing unit to be memorized for various purposes and/or analyzed in real time, for example, to send help if the physiological parameters of the wearer were to signal, for example, that he is suffering a serious illness (heart attack, epileptic fit, etc.) or if one of the physical and/or chemical parameters of the environment of the wearer were to present an abnormal value. This embodiment of the invention meets the requirement to improve the protection of people, living beings, goods or objects by monitoring certain chemical and/or physical parameters and/or, even, where appropriate, physiological parameters and by warning the wearer himself, his party or a central surveillance system if the value of one of the audited parameters were to depart from the normal.

In another additional embodiment of the inventive installation, the badge capable of displacement comprises a second memory, the function of which is to memorize and store parameters of the environment of said badge capable of displacement, obtained by means of sensors or other equivalent means, and the space position of said badge relative to one or more beacons, said second memory being suitable for being read by the interface. This additional embodiment of the installation allows traceability of the badge and therefore of its wearer. It makes it possible to provide monitoring of the displacement of the badge and can then be applied to ensure the traceability of the badge or the security of the badge and/or, of its user and/or of its environment. In certain cases, the badge can take the initiative to communicate to the processing unit, via the interface and/or the beacons, the data contained in this second memory or transmit, directly and in real time, to the processing unit, via the interface and/or the beacons, the data that it collects.

In a particular embodiment of the additional particularly advantageous execution variant of the invention described hereinabove, it is possible to link the processing unit to a device for displaying map drawings or plans to represent therein, in real time or offline, the displacements of the wearers of the badge in the place controlled by the installation as well as the specific events signaled by the badge. By analyzing this data, including the location data, it therefore provides the people concerned with additional elements in their investigation in searching for the author or the cause of an event, of an accident or of a misdeed. The invention also makes provision for reacting and signaling if a user ought to leave the area which is under the control of the installation.

In a preferred form of execution of the invention, the functions of the programming unit as well as those of the control device intended to send specific commands to the badges will be incorporated in the processing unit.

In another additional particularly advantageous form of execution of the invention described hereinabove, it is possible to add to the badge capable of displacement a microphone and a sound diffuser (an earphone or an earpiece, for example) which will enable the wearer of the badge to dialog with one or more other wearers by using the energy wave signals exchanged between the badge and the interface and/or the beacons. Since each badge capable of displacement has an identifier specific to it, the audio signals from as badge can also be identified uniquely, making it possible to distinguish them. It will therefore be possible for the installation to convey several audio conversations without mixing them while establishing a common communication between several wearers. Management of the audio communications can be handled by the processing unit. A variant of the invention provides for the technique described hereinabove for audio communications to be extended to communications of other signal types such as image, film, file or computer data communications (exemplary and non-exhaustive list) by equipping the badge with ad hoc peripheral devices.

In another addition especially advantageous variant of its embodiment, the invention provides a control means making it possible to detect the correlation between the monitoring device (the badge) and its wearer. This principle prevents an intruder from being able to appropriate the authorizations of a wearer by stealing or substituting his badge. An advantageous method provided by the invention consists in coupling the badge with another object, an RFID, for example, with which the wearer of the badge is equipped (or that is incorporated in the wearer of the badge) and which is specific to this wearer (unique identifier). In this case, the badge will regularly verify the presence and the proximity of this object to see if the object or itself has not been taken off its wearer. If the badge confirms that it is no longer coupled with the object concerned, it will assume a permanent alarm condition and also transmit this alarm to the processing unit mentioned hereinabove using the transmitter with which it is equipped via the beacons and/or the interface. This embodiment will be particularly advantageously used when the badge is not solidly incorporated in its wearer because it thus makes it virtually impossible to usurp the identity of its wearer. The term “RFID” is used to designate small objects comprising an antenna associated with an electronic chip containing data including a unique identifier. These small objects can receive a request by radio wave transmitted by a transceiver to which they respond by transmitting the data contained in the electronic chip including their identifier.

In the case where the wearer of the badge is a human being, an especially advantageous embodiment of the other additional particularly advantageous execution variant of the invention described hereinabove consists in incorporating this RFID in underclothing equipped with sensors of various types including those measuring physiological data of the wearer. Since the sensors are connected to this RFID, the badge will collect the data from these sensors by interrogating the RFID and it can process said data autonomously and/or communicate it to the processing unit via its energy wave transmitter and the energy wave receiver of the interface and/or of the beacons.

In a particularly advantageous form of execution of the invention, the badges can also handle the role of beacons. The functional multipurpose nature of the badges is a noteworthy characteristic of the invention. This versatility is of particular interest for improving the locating accuracy of the badges capable of displacement and for making certain physical embodiments of the invention possible. In practice, the processing unit of the installation can easily distinguish the badges capable of displacement that occupy, for a more or less long moment, a fixed position. The processing unit can then give the instruction to the suspect badge to handle the role of beacon. The badges capable of displacement that receive this additional signal will therefore have additional location information, which will make it possible to improve the computation of their position. By repeating this operation with a number of badges, it will be possible to establish an even more accurate map of the badges and be able to achieve a pixellization of the badges on a drawing, a plan or a map. This particularly advantageous form of execution of the invention can also be applied to the badges capable of displacement that are subject to permanent displacement. This makes it possible to more easily produce certain practical embodiments of the invention. The example of an advantageous execution variant of the invention which exploits this multipurpose nature of the badges will be described hereinbelow.

An important, exemplary and noteworthy particular feature of the invention is that the badge is autonomous both when it comes to computing its position and with respect to the actions that its operating program imposes on the actuation member. However, the miniaturization of the electronics and the minimization of the energy consumption of the badge limit the volume of the data memorized and the scope of its computation potential. Thus, to overcome the limitations imposed by the art, an advantageous execution variant of the invention provides, if necessary, for collaborative working mode operation between the badge and the processing unit in order to improve, among other things, the badge positioning computation. A number of methods of this collaborative working can be implemented. A first consists in having the badge transmit to the processing unit the data sent by the beacons that it has collected. The processing unit can use this data in more sophisticated statistical computations which will take account, among other things, of more data than those relating to the history of the displacement of the badge, theoretical statistical badge position forecasts, histograms of the signals sent by the beacon or beacons and, where appropriate, installation self-monitoring data to determine with significantly better accuracy the location of the badge. When this computation is completed, the processing unit can communicate to the badge more accurate coordinates of the position of said badge, coordinates that its operating program can take into account to activate the actuation member and also in the next autonomous computation of its position. In addition to the coordinates resulting from the computation, the processing unit can also send to the badge specific instructions or a new operating program to replace the badge's active operating program. A second method is based on the first but preferred inasmuch as, after its computation, the processing unit communicates to the badge its positioning coordinates but also, where appropriate, modifies the topography and/or spatialization tables of the badge. With this method, the data available to the operating program of the badge is improved as the badge is used, which advances the accuracy of its autonomous position computations. The third method is similar to the second except that the data sent by the badge to the processing unit is augmented. In practice, in this method, a desired characteristic of the invention is fully exploited, namely the multipurpose nature of the elements that make up the installation. This multifunctional characteristic of the elements of the invention means, among other things, that the badges can serve as beacons. Thus, the badge concerned can also listen for the signals transmitted by the other badges and use them in the same way that it uses the signals transmitted by the beacons. It will therefore transmit this data to the processing unit which will consolidate it, enabling the latter to compute even more accurately not only the position of said badge but also that of the other badges. The fourth and final method that we will explain here runs counter to the desired autonomy of the badge in the invention but may be advantageous in certain application cases. It consists in having the badge transmit to the processing unit the data that it has gathered then in having its operating program wait to receive the result of the positioning computations performed by the processing unit and any one-off instructions and/or new spatialization table and/or new topography table and/or new operating program for its operating program (possibly new operating program) to act on its actuation member.

In an especially advantageous form of execution of the various forms and variants of execution of the invention defined above, the installation comprises at least two beacons linked by a network (by means of cabling with a bus-type topology (shared cable) or star-type topology comprising dedicated cables, computer network cables, electricity network cables or by means of a transmission by energy waves), each beacon comprising a transceiver of energy waves and a memory as explained above. However, the beacons no longer need to be provided with a clock if the pacing of their transmission is handled by the device managing the network. One method of setting up the network comprises a scanning of the badge capable of displacement, in succession by the transmitter of each beacon, acting individually. For example, in the case where the installation comprises, on the one hand, five badges capable of displacement each provided with a radiation source and a receiver and, on the other hand, four beacons each provided with a transmitter, the receiver of each batch capable of displacement (considered individually) is scanned by a succession of four individual signals, originating respectively, successively and in an order that can be predefined from the beacons. This execution variant of the invention is not, however, limited to this network implementation method, it can be replaced by other known methods, for example a network with a protocol that allows collisions. The beacons can immaterially all be fixed or all be capable of displacement; as a variant, some of them can be fixed, while others are capable of displacement. The type of network is not critical to the invention and the latter allows for the simultaneous use of several network types. The choice of the network type or types will depend on various elements, including those relating to the environment in which the invention is used. The management or supervision of the network can be handled by a “master” beacon or a dedicated device. In an advantageous embodiment of the invention, the network management will be handled by the processing unit.

In an additional and particularly advantageous form of the especially advantageous execution variant described hereinabove, it is possible to improve the protection of the people and living beings or objects provided with a natural or artificial intelligence capable of understanding the signals transmitted by the badges when an incident or an accident occurs in a place by transmitting signals that can be perceived by said living beings, people or objects, to guide them to exits which will allow them to leave the place with maximum safety. A variant of this additional particularly advantageous embodiment of the invention provides for the badges to be provided with a personal sound diffuser (such as an earphone) to guide its wearer by messages (synthesized or prerecorded) chosen automatically by the badge with, if necessary, the support of the processing unit and/or of the beacons. Another variant of this additional and particularly advantageous form of installation of the invention provides for the fixed beacons that are visible to be equipped with one or more energy radiation sources for which the processing unit will organize actuation so as to indicate, like the badges capable of displacement as mentioned hereinabove, the hazard-free paths that lead to the exits from the enclosure covered by the invention.

A particular execution of the installation according to the invention provides for the beacons to be equipped with conventional sensors or detectors of fire, smoke and/or gas, including toxic gases, or even motion, intrusion and other hazard detectors. The aim of this execution is simply to avoid multiplying the security elements in the places to be protected. However, the incorporation of certain sensors or detectors in the beacons may prove relevant for detecting some specific cases. For example, some sophisticated volumetric presence and/or motion detectors can establish with relatively good accuracy the number of beings or objects that they have identified. By comparing this data with the number of badges present at the beacon provided with said detector, it is therefore possible to establish the probability of the presence of one or more intruders and therefore communicate a specific warning. Whatever the case, if the beacons are equipped with detectors or sensors, they report on the state of the latter to the processing unit which can, if necessary, relay this information to one or more central systems dedicated to managing this type of sensor or detector.

In an additional form of execution of the inventive installation, provision is made, like in the systems based on the use of GPS, to be able to ask the badge to guide its wearer to a predefined point in the place covered by the invention. This automatic guidance can be implemented in a number of ways according to the energy radiation sources with which the badge, and/or the peripheral device or devices that it controls, is provided. A preferred form extends to directing by sound, for example, in the form of simple synthesized or prerecorded guidance messages and transmitted to the wearer via a sound diffuser (personal preference, such as an earphone) or directing by image such as a summary image produced by a display screen (preferably hand-held and individual) which reproduces, in real time, a plan or a map of the places, the position of the wearer of the badge, the direction to follow and, depending on the scale of the diagram, the destination.

In an additional execution variant of the especially advantageous embodiment described above, the link by energy waves between the transmitter (or, where appropriate, the transceiver) of the interface and the receiver (or, where appropriate, the transceiver) of one or more beacons passes through at least one transmission relay equipped with a transceiver of energy waves (for example, a microwave relay). This variant of the invention is of interest in the case of installations in which the interface and/or the beacons are intended to be positioned or displaced over a large surface area or one which presents natural or artificial obstacles to the propagation of the energy waves. In a specific embodiment of the additional execution variant of the especially advantageous embodiment described above, the relay function can be handled by one or more beacons.

In a specific embodiment of the inventive installation, the energy radiation source of the badge capable of displacement comprises a relay. In this embodiment of the invention, the relay is intended to actuate a mechanism present on the badge capable of displacement or separate from the latter, in response to an instruction originating from the actuation member.

In an additional embodiment of the invention, the installation comprises a marking unit for the badges capable of displacement and their peripheral devices, including the RFIDs associated with the badges capable of displacement. In this additional embodiment of the invention, it may prove advantageous for the installation also to include a marking unit for its other components, such as the processing unit, the programming unit, the interface and/or the beacons, etc. This particular embodiment of the invention makes it possible to distinguish the elements of an installation according to the invention from the corresponding elements of another installation according to the invention. It thus prevents an element of a determined installation (for example, a badge or a beacon) from being able to be replaced by a corresponding element of another installation. The installation has also provided a procedure that enables differently marked elements to be able to be used simultaneously in one and the same installation as if they were all marked in the same way.

In a particular variant embodiment of the invention, it is possible to add passive beacons (unlike the active beacons equipped with a transmitter that is active independently of the presence of badges), for example, passive RFIDs, or replace (in whole or in part) the active beacons with passive beacons that will be less costly. In this case, it will be the badge that will read the information from the passive beacon to identify it. The operating program will take account of this data in the same way as it uses the data transmitted by the active beacons. The advantage of this particular variant of the invention is that it is possible to augment the number of beacons at lower cost while improving the badge position computation accuracy.

In another advantageous embodiment of the invention, the badges and/or the interface and/or the beacons and/or the transmission relays can be equipped with a number of transmission and/or reception antennas oriented in different ways so as to overcome the directivity of the transmission and reception field of the antennas as well as the behavior of the energy waves in a confined medium and so improve communication and also the positioning accuracy of the badges capable of displacement.

In a particularly advantageous embodiment of the invention, the badges and/or the interface and/or the beacons use different frequency bands and/or jointly a number of frequency bands of the energy wave and/or, even, jointly several energy wave types for the transmission and reception of the signals. This particular feature makes it possible to augment the number and/or the speed of the signals transmitted or exchanged. In this advantageous embodiment of the invention, the badges and/or the interface and/or the beacons can be equipped with a number of transmitters and/or receivers suited to this embodiment. This particularly advantageous embodiment of the invention also enables the installation to remain functional even if an external phenomenon were to use and therefore disrupt a portion of the frequency bands of the energy waves used in an installation. The invention provides for the installation to automatically change the frequency bands that it uses in order to avoid frequency bands which are subject to such disruption. These changes can be logged in the processing unit.

In a particularly advantageous form of execution of the invention, provision is made for the installation to be automatically calibrated as regards the setting of the parameters associated with the transmission of the energy waves. Provision is also made for the installation to automatically modify said settings so as to be adapted to the external disruptions and also, as best as can be, to the one-off and/or unscheduled changes of layout of the places and signal with a warning if this automatic procedure is made impossible for whatever reason. This automatic calibration will be managed by the processing unit which will use the signals and data that it receives from the various elements of the installation in normal mode of use, but also data that it will collect specifically for this purpose by commanding certain special actions on the part of the components of the installation without, however, disrupting their normal operation. The adaptation of the parameters by this automatic calibration function will, however, be deliberately limited in order for the installation not to correct a malfunction or a sabotage attempt on one of its components without triggering a warning. The adaptations of the abovementioned parameters can be logged in the processing unit.

The invention provides for, permanently or cyclically, depending on the importance of this function in the context of the use of the invention, the installation to monitor the correct operation of all its component elements. This function will be handled and managed by the processing unit which will signal any malfunction by transmitting a warning suited to the problem encountered. Another objective of this function is to detect any sabotage or bypass attempts to which the installation might be subject. The badges capable of displacement, as well as all the elements of the installation, will also perform, for their own account, this self-monitoring function, particularly, for those that are provided with an autonomous energy source, the monitoring of the energy reserve remaining in said autonomous energy source. If need be, the element that observes a problem will transmit a warning to the processing unit in the case of the badge capable of displacement, the latter will transmit a local warning effect to warn its wearer or any other person in his party. All these controls and warnings can be logged in the processing unit.

The invention provides for its own clock, as well as that of its component elements that are provided with a clock or a time-related counting system, to be periodically synchronized. If the processing unit is linked to a time source such as an atomic clock or a time server, it will use the time service of this time source to synchronize its own clock before synchronizing that of the other elements.

In the inventive installation, a number of warning transmission scenarios are provided. The invention provides for these warnings to be signaled as much by conventional methods such as display on a screen, the illumination of a warning indicator or the transmission of a sound transmitted by a diffuser, a klaxon or a siren, as by new methods that use modern telecommunication means (warning by written or voice message on a fixed or portable telephone, on the computer work station of a manager or an operator, etc.). If the warnings are transmitted to a remote site, the self-monitoring procedures will provide for the correct operation of the communication means that link the processing unit of the installation and the processing infrastructure of the remote site to be verified, just as the infrastructure of the remote site will permanently or regularly verify the correct operation of the processing unit of the installation and, consequently, the overall correct operation of the installation. It follows that the communication means used will be the subject of particular attention regarding their security. All of the warnings transmitted by the installation can be logged in the processing unit.

An execution variant of the invention provides, among other things for major installations, for the processing unit to be able to be made up of a number of networked processing units. The organization of the processing units can be based both on a geographical distribution and on a distribution of the functions. The type of network that links the processing units is not critical to the invention. The choice of network type will depend on the topology of the network and also on that of the places and the environment.

A specific embodiment of the invention provides for the location data of the badges and of the other elements of the installation for which the installation knows the location data (the beacons, for example), to be able to be formulated in terms of absolute geographic coordinates (latitude and longitude) by indicating to the processing unit the absolute geographic coordinates of two fixed points located in the place covered by the installation (two fixed beacons, for example) or even the geographic coordinates of a single fixed point and an orientation axis. In the case where the installation is situated in a mobile place (a boat, for example), the installation must either be complemented with two GPS receivers that will be positioned at fixed points relative to the place covered by the installation and that must be linked to the processing unit in order for the latter to be able to take account of the geographic coordinates that vary in time of these two reference points in its computation to transpose the local location data of a predetermined moment into absolute geographic coordinates.

In the inventive installation, the badge capable of displacement must be equipped with an autonomous electricity generator, in particular to handle the operation of its actuation member. Similarly, in the case where the programming unit is capable of displacement, it must normally be equipped with an autonomous electricity generator. The same applies for the interface if the latter is capable of displacement or can be dissociated from the programming unit as well as certain beacons. The autonomous electricity generator of the badge capable of displacement and, where appropriate, of the programming unit and/or of the interface and/or of the beacon is not critical to the definition of the invention. Its choice will depend on various parameters, such as the nature, the shape, the dimensions and the destination of the badge capable of displacement (and, where appropriate, of the programming unit and/or of the interface and/or of the beacon). It may an alternating current generator or a direct current generator. Depending on the circumstances, the autonomous electricity generator can, for example, be chosen from electric batteries, fuel cells and electric accumulators (such as capacitors and rechargeable electric batteries). When they are fixed, the programming unit and the interface can be equipped with an autonomous electricity generator or be linked to the mains electricity network or powered via the link cable with the processing unit. In a particular embodiment of the inventive installation, the abovementioned interface comprises a clear or induction-based electrical coupling, the application of which is known and a link by energy waves (involving one or more beacons and, where appropriate, one or more relays, these elements having been defined and explained above). This embodiment is well suited to the installations that include rechargeable electric accumulators and marking units for its components. The clear or induction-based electrical coupling is then used to produce the marking of the components and to couple the electric accumulators to an electric charger, while the link by energy waves is used to place the programming unit in communication with the memory of the actuation member of the badge capable of displacement. In a modified embodiment, the clear or induction-based electric coupling is also used to place the programming unit in communication with the memory of the actuation member of the badge capable of displacement. In this modified embodiment of the invention, the electrical coupling is used to transfer an operating program into said memory, starting from a program that is preestablished and prestored in the programming unit, whereas the link by beacons and energy waves is used, while the installation is in use, to adapt, in real time, this operating program or to send it instructions specific to local circumstances such as ambient pressure and temperature, ambient light, the space position of the badge capable of displacement, the presence of natural or artificial obstacles, the topography of the places (exemplary and non-limiting list).

For the electronics of the inventive installation, components with small dimensions and low energy consumption will preferably be chosen. The invention thus makes it possible to miniaturize the components of the installation and reduce its electrical consumption, both when active and when idle. The electronics of the badge are designed in a modular way with the particular feature that each functional module can be separately placed on standby. The design of the operating program takes maximum account of this particular feature and thus prioritizes the placing on standby of those modules whose activity is not necessary to it. For example, the operating program of the badges on which a very long periodicity between two location computations (every hour or once a day, once a month or even once a year) has been imposed, will place on standby almost all of the electronics of the badge during moments when it is not active, so reducing its energy consumption to the absolute minimum (a few microamps). The invention provides for various unprogrammed badge wake-up methods, including equipping it with an accelerometer with adjustable sensitivity. If the accelerometer applied to the badge exceeds a set threshold, the accelerometer will reawaken the operating program of the badge which will then analyze the reason why it has been woken up and act according to the instructions provided therefor in this circumstance.

The inventive installation has applications in a varied number of areas, scenarios and places such as, for example, offices, manufacturing shop floors, nuclear power plants or other at-risk enterprises, hospitals, buildings, structures or organizations that accommodate people who have to be subject to tracking or surveillance, airports, tourist, cultural or training infrastructures, banks, administrative centers, military infrastructures, equipment maintenance tracking, companies in general, office buildings shared by multiple companies, identity protection, logistics (for tracking packages in general and more specifically hazardous, rare, precious or high-value objects or living beings), sales areas (both in the general area of security and protection but also for marketing surveys), the medical field, geomatics (it enables geomatics to depart from its static aspect to implement dynamic geomatics applications by the real time tracking of objects and also living beings), etc. (exemplary and non-exhaustive list).

Among the examples that we will not be describing in detail, there is the help that the invention can provide to emergency services regarding the evacuation of places and assistance, and all from its most elementary embodiment. In practice, the invention can easily inform the operatives if there are still people, living beings or objects still in danger in the suspect parts of the place without requiring that the wearers pass through specific access controls to signal their exit from the place at the time of evacuation. It thus enables them to intervene more effectively to save threatened wearers, notably by being able to indicate their presence but also and above all their location. Furthermore, it can even assist the rescuers by guiding them in the places in a secure manner and by the shortest route (without hazard) to reach them. As described previously in the text, this guidance can be provided by means of audio messages or by display on a handheld screen of the plan of the places where the dangerous spots, as well as the position of the operative and that of the wearer to be rescued, are indicated. To make things easier for the operative, the invention also allows for the guidance of the latter to be performed remotely by a person located outside the places (a local crisis center, for example) and who has a display screen as described hereinabove while having, because of his position, a knowledge of more global data relating, among other things, to the organization of all of the assistance and how the incident is developing.

In a quite different aspect of practical life, the invention can even be used to qualify its wearer, for example, by means of a light signal. For example, by having the badge (or a peripheral device controlled by the latter) emit a specific color to distinguish people who are part of the staff of the occupant of the places from external people required to carry out precise subcontract work and visitors.

### BRIEF DESCRIPTION OF THE FIGURES

Particular features and details of the invention will become apparent from the following description of the appended figures which represent a few particular embodiments of the invention.

FIG. 1 diagrammatically represents a small-size installation;

FIG. 2 diagrammatically represents a storage location covered by another type of inventive installation;

FIG. 3 is a sketch of a hypermarket and another exemplary embodiment of the invention;

FIG. 4 presents an exemplary installation in a building subject to high surveillance;

FIG. 5 represents a block diagram of an installation intended to provide services to improve and secure site visits;

FIG. 6 is a block diagram of an installation in the maintenance field.

### DETAILED DESCRIPTION OF PARTICULAR EMBODIMENTS

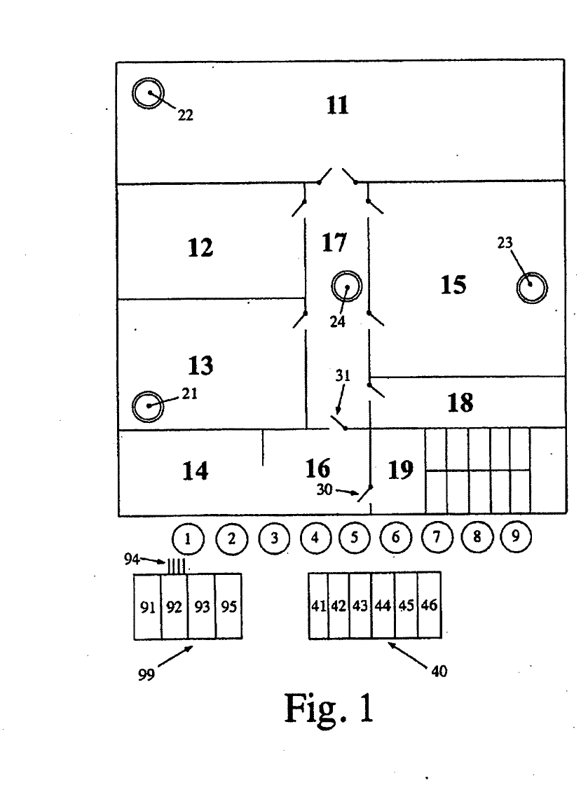

FIG. 1 represents the floor of a building covered by a small-size installation. It is intended to explain in detail the initialization of an element in a system and some behaviors of the operating program of the badges including the warning-triggering behavior.

The installation represented comprises:
a processing unit 99 comprising a programming unit 91, an interface 92 provided with a receiver 93 of microwaves in the 2.4 GHz ISM (Industry, Science and Medical, the frequency bands that can be used freely for industrial, scientific and medical applications) band, as well as four physical links 94 with the four beacons and a siren 95. In this example, the interface functions were therefore partially combined with those of the beacons;
four beacons numbered from 21 to 24 each equipped with a transmitter of microwaves in the 2.4 GHz ISM band. They are each connected to the interface 92 of the processing unit 99 by a physical link 94 which handles data transmission, but also the power supplied to the beacons (beacons connected by star topology). In this case, the beacons are not, and cannot be, autonomous since they contain no autonomous power supply or memory. In detail, a beacon in this case is reduced to a microwave transmitter driven by the processing unit and linked to the latter by a cable 94 which also supplies the transmitter with power.
nine badges capable of displacement numbered from 1 to 9, each equipped with a light source, a membrane sound transmitter and a 2.4 GHz ISM band microwave transceiver. The detail of the badges 1 to 9 of the installation described here is shown in a badge 40 which comprises an energy source 41, a monochrome LED 42, a membrane sound transmitter 43, an actuating member 44 for the LED 42 and for the membrane sound transmitter 43, a memory 45 and a microwave transceiver 46.

The floor comprises four offices numbered from 11 to 14, a meeting room 15, a reception hall 16, a corridor 17, amenities 18 and access by, a stairwell 19. The entry door to the floor 30 and the door 31 which gives access to the offices from the reception hall are equipped with a lock with electric door opener, preventing people from entering the offices without authorization.

Authorizations to access the premises are set as follows:
except for badges 5 to 9 reserved for any visitors, each badge wearer has an office that is his own and in which he is obviously allowed to be present without limitation (so as not to complicate the example). Thus, the personal offices of the wearers of badges 1, 2, 3, and 4 are, respectively, offices 11, 12, 13 and 14;
the wearers of all the badges, including visitors, can be present in the meeting room 16, the corridor 17 and the amenities 18;
access to the stairwell 19 is prohibited to all badges, which prevents their wearers from leaving the floor with their badge;
the wearer of any badge (including visitors) can access an office other than his own provided that the occupant of the office is present therein;
the manager of the company is the wearer of badge 1. He has unlimited authorization to access all premises;
in addition to his personal office 12, the assistant manager, the wearer of badge 2, has authorization for the other offices except for office 11;
the wearer of badge 3 has no specific authorizations;
the secretary who wears badge 14 has authorization to enter all the offices, but limited to one minute if the occupant is absent;

The description starts from the fact that, during set-up, in the installation initialization and test phase, the installer has prestored in the programming unit the data deriving from technical operations, in particular the data relating to the layout of the premises. He will similarly have parameterized the beacons because this task also involves technical operations.

### Initialization by the Installer

Before the user becomes involved, the main parameters are set as follows:
the programming unit of the processing unit knows the following data: its (manufacturing) serial number is S0, the system to which it belongs has the number 111, the encryption keys of the system are the keys X and Y and the encryption method used is the method Z, the scanning interval is 5 seconds, the transmission power of the badges is set at P0. The invention provides for the system number to be unique. It will be assigned by an algorithm that will use certain data supplied by the operator who initializes the system (and therefore known to him alone) as well as the unique serial number of the programming unit. The number 111 is therefore given solely by way of example;
the beacon 21 has the serial number S1, belongs to the system 111, it has the number 1 in the system and transmits at power P1, the encryption keys and method are identical to those of the system;
the beacon 22 has the serial number S2, belongs to the system 111, it has the number 2 in the system and transmits at power P2, the encryption keys and method are identical to those of the system;
the beacon 23 has the serial number S3, belongs to the system 111, it has the number 3 in the system and transmits at power P3, the encryption keys and method are identical to those of the system;
the beacon 24 has the serial number S4, belongs to the system 111, it has the number 4 in the system and transmits at power P4, the encryption keys and method are identical to those of the system;

Before using the installation, the user must set the functions and authorizations of the badges. He will carry out this operation using the programming unit and the interface.

As has already been mentioned above, each element has, from its manufacture or from when it is placed on the market, a unique serial number. It is this unique number that will be used to initialize the elements for the first time.

### Initialization of the Badges by the User

The user will therefore set badge 1 as follows:

a) He will give the programming unit, or obtain from the latter, certain parameters such as:
Entry of the manufacturing serial number S1 of the batch 1. This number is essential because the badge is not yet known to the system and its manufacturing serial number is the only possible and unequivocal identification means. By supplying this datum, the programming unit is also warned that it is a new element of the system that it coordinates.
System number: given by the programming unit (in this case 111).
Number of the badge in the system: given automatically by the programming unit (this will be 1).
Location computation mode: given by the programming unit—initialized by the installer. In this case, the computation mode Will be autonomous.
Limited authorizations: none.
Prohibitions: room 19—10. The 10 represents the seriousness of the warning. It indicates to the operating program the actions that it must undertake if the badge is in this situation. In the example given here, the behavior of the badge according to the warning levels is a prestored program in the programming unit since it is common to all the badges.
Beacon option: yes. By this setting, the programming unit will assign a beacon number to the batch (this will be 5). In practice, the latter must handle this function for the other badges, when they are in the office of the CEO, to be able to determine if the CEO is present or not.

Once this data is set, the programming unit will enter into contact with the badge to initialize it. This exchange of messages will, be conducted via the transmitters of the beacons 21 to 24 and the receiving part of the transceiver of the badge for the messages sent by the programming unit 91 and via the transmitter part of the transceiver of the badge and the receiver 93 of the interface for the messages transmitted by the badge. Throughout the badge initialization procedure, the messages exchanged will be marked specifically to distinguish them from the messages intended for normal operation of the installation and until the encryption of the messages is in its final form, it will be the manufacturing serial number of the badge that will be used as an identifier for the messages.

b) The first step of this first contact will consist in exchanging the data needed to encrypt the messages exchanged. This step will not be explained here because it is based on encryption procedures that are conventional and known. However, it should be added that this step will not be carried through to completion if the badge is already assigned to a system. In this case, the badge will very quickly signal this fact to the programming unit and the initialization procedure for the badge concerned will be stopped. The programming unit will signal to the user the reason for the procedure being stopped with an ad hoc message. It should be specified that, if this does occur, the identification number of the system to which the badge belongs will not be communicated by the badge to the programming unit, let alone to the user. It is a procedure that prevents a user from appropriating a badge that does not belong to him. As stated above, a procedure can be applied to have a number of systems operate as if they were just one but this requires a knowledge of certain confidential information concerning the pooled systems.
c) If the procedure continues, it goes on to the present step, the final objective of which is to incorporate the badge in the system. The programming unit will send the badge the information necessary for its correct operation such as the topography and spatialization tables that, are used in the computation carried out by the badge to determine its position, the method of computing its position, the number of the system to which it belongs, its badge number in the system and, in the present case, its beacon number in the system as well as its prohibitions. It should be specified that some of this data is in the form of the operating program mentioned above that the programming unit communicates to the badge during this initialization phase.
d) Once the badge has processed and memorized this data, it will send a message to the programming unit to confirm its attachment to the system and therefore its operational state. Regarding the data that it has received from the programming unit, the badge will memorize it in a non-volatile part of its memory, which means that, if it were to be deprived of energy, this data would not be erased from the memory. This memorization mode pursues at least two objectives: the first, practical, is not to require the user to have to reinitialize the badge if its battery fails; the second concerns the badge protection procedure preventing the initialization of a badge that already belongs to an installation.

When this operation is finished, the user will proceed to initialize the second badge and subsequent badges in the same way. Only the data specific to each badge is given hereinbelow, whether this data is encoded by the user in the programming unit or given by the latter:

e) Badge 2 data:
Manufacturing serial number: S2;
System number: given by the programming unit (in this case 111);
Badge number in the system: given automatically by the programming unit (this will be 2);
Limited authorizations; room 11+badge 1—5 (this means that badge 2 is not authorized to be in room 11 unless badge 1 is also there and that, otherwise, the badge will enter into a type 5 warning);
Prohibitions: room 19—10;
Beacon option: yes (this will be 6).
   f) Badge 3 data:
Manufacturing serial number: S3;
System number: given by the programming unit (in this case 111);
Badge number in the system: given automatically by the programming unit (this will be 3);
Limited authorizations; room 11+badge 1—7, room 12+badge 2—5, room 14+badge 4—2;
Prohibitions: room 19—10;
Beacon option: yes (this will be 7).
   g) Badge 4 data:
Manufacturing serial number: S4;
System number: given by the programming unit (in this case 111);
Badge number in the system: given automatically by the programming unit (this will be 4);
Limited authorizations; room 11+badge 1—7, room 12+badge 2—5, room 13+badge 3—2, room 11<1 min—7 (this means that the badge can enter room 11 but cannot remain there for longer than one minute if he is alone in the room), room 12<1 min—5, room 13<1 min—5;
Prohibitions: room 19—10;
Beacon option: yes (this will be 8).
   h) Badges 5 to 9 data (visitors):
Manufacturing serial number: successively S5, S6, S7, S8 or S9;
System number: given by the programming unit (in this case 111);
Badge number in the system: given automatically by the programming unit (this will be in succession 5, 6, 7, 8, 9);
Limited authorizations; room 11+badge 1—10, room 12+badge 2—7, room 13+badge 3—7, room 14+badge 4—5;
Prohibitions: room 19—10;
Beacon option: no: the security scenario does not provide for the visitor badges to lead to an authorization. They are therefore never used as beacons.

By comparing the instructions concerning the limited authorizations assigned to the different badges, it can be seen that, given the same circumstances of a warning, the warning levels are obviously higher for the badges of the invitees than those of personnel.

The limited authorization instructions are given here by way of example. They can include numerous other parameters in addition to those indicated here such as, for example, a period of grace before triggering the warning, a warning repeat period, an additional instruction intended for the processing unit or another badge, etc.

The programming unit will obviously check that the security constraints are consistent. For example, if it finds that, in one constraint, the presence of the CEO is tested and the badge of the CEO is not activated to handle the mobile beacon role, it will signal it to the operator and, in certain cases, propose the necessary correction to ensure the consistency of the security rules.

When the badges are initialized, the installation is fully operational.

### Explanation of how the System Operates in Normal Mode.

Every 5 seconds, the programming unit will have their signal transmitted in succession to each of the fixed beacons and the badges 1 to 4—in their beacon function. The beacons, whether fixed or mobile, will transmit a message containing at least the following data: a frame announcing that this message is a positioning message, the beacon number, the beacon type (fixed, mobile reliable or mobile without control), the position coordinates, the transmission power (exemplary and non-exhaustive list).

At the outset, the processing unit will send to the transmitter of the beacon 21 the message that it has to transmit. Then, it will do the same with the beacon 22, then 23, then the beacon 24. Immediately after, it will send via the transmitters of the beacons an order to the badge 1 that has the beacon number 5 to transmit, in its turn, a message as beacon. Since it is the first scan, the badge 1 has not yet been able to compute its position and therefore will not transmit any positioning message. The same applies for the badges 2, 3 and 4. The processing unit will then send, via the transmitters of the fixed beacons, a message indicating that the transmission (the scanning) of the beacons is finished and that the badges can be begin to compute their position. This therefore ends the first scan by the beacons.

At the badge level, each has then received, ideally, the message from at least three of the four beacons (the installer will have had to check this), the badges not having transmitted any positioning message. If a badge has received less than three beacon positioning messages including two from fixed or mobile reliable (in security terms) beacons, it cannot normally compute its position but, thanks to the topography and spatialization table and its statistical computations, it may be, in certain cases, that it can even so determine its position. If this is not the case, it will await the next scan to compute it. If, after a fixed number of scans, it has still not received at least three signals (including at least two from fixed or mobile reliable beacons), it will be set to the warning mode and also transmit a warning to the processing unit. This should not in fact occur unless the badge begins to leave the coverage of the system.

If the badge has received at least three positioning signals (including two from fixed or mobile reliable beacons), it will compute its position using the received data. The position computation is based on the comparison of the result of a number of computations involving statistical methods of processing the data transmitted by the beacons and probability computations concerning the most probable position of the badge according to the history of its displacements, but also comparison with histograms of various positions of the place covered by the installation as well as data obtained from the spatialization and topography tables.

Once it has computed its position, its operating program will follow its decision logic and, where appropriate, will act on the actuation member of the LED and/or of the membrane sound transmitter and, if this functionality is provided, communicate an ad hoc message to the processing unit. Some concrete examples are taken up hereinbelow, but before looking at these, we will examine the way in which the second scan proceeds assuming that all the badges have been able to calculate their position following the first scan. During the second scan, the fixed beacons 21 to 24 will send their positioning signal, as will the badges 1 to 4 since, each knowing their position, they can carry out their mobile beacon role.

Thanks to this second scan, assumed to be successful, everything is in place to describe a few concrete badge behavior scenarios.

### Example of Some Behaviors of the Badge Operating Program

The CEO and his assistant are in the CEO's office 11. The badge 1 of the CEO has computed that it is in the office 11 for which it has no security constraints. It therefore sets itself to await the next scan. The badge 2 of the assistant has also computed that it is in the office 11 for which it has a constraint that requires that the badge 1 (or more precisely, the beacon 5) is also in the office 11. It therefore examines the position that it has received from the beacon 5 (therefore from the badge 1) and observes that it is located in the office 11. Since the condition is satisfied, it can set itself to await the next scan.
The secretary is in the office 12. His badge (number 4) has computed that it is located in the office 12 for which it has a number of constraints: the priority constraint is to remain less than one minute if the assistant CEO is not in the office. The operating program of the secretary's badge therefore checks to see if the assistant CEO is in the office by examining the position of the badge 2 (or more precisely, of the beacon 6). It observes that the latter is not in the office and therefore runs, in the background, a countdown from one minute. This countdown can be stopped on a subsequent scan if the badge of the secretary computes that it is no longer in the office of the assistant CEO or if it observes that it is still in the office of the assistant CEO but the latter is also present. If the countdown reaches 0, the operating program of the secretary's badge will carry out the actions provided for type 5 warnings (limited authorization instruction “room 12<1 min—5”) for the badge 4 worn by the secretary.
The wearer of the badge 3 has entered the office 14 of the secretary. The operating program observes that it is subject to a limited authorization in this room (room 14+badge 4—2). It examines the position that the badge 4 (or more precisely, the beacon 8) of the secretary has sent and observes that the badge is not, in the room 14. Since, in the limited authorization parameters, no period has been indicated, the operating program of the badge 3 immediately carries out the actions of a type 2 warning (a low warning because the objective of this warning is mainly to notify the wearer, of the badge himself and, possibly, to draw the attention of the other people in the offices). The operating program of the offending badge triggers a background task which drives the membrane sound source for it to transmit a brief sound with a slow periodicity, then sends, to the processing unit, a warning message specifying that it should only log the warning and not undertake any other action. The warning transmitted by the badge will be stopped immediately the wearer of the badge 3 leaves the office of the secretary or the latter returns to his office.

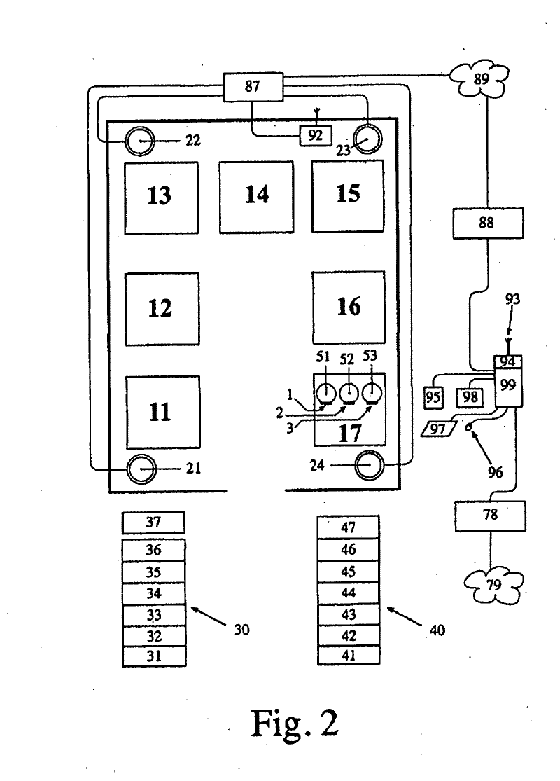

FIG. 2 diagrammatically represents a storage place covered by the invention. It explains the assistance provided by the invention when it comes to security in stocks and the noteworthy means that it can implement to correct a fault which could have serious consequences.

The installation comprises:
a processing unit 99 linked to a display screen 98, a keyboard 97 and a mouse 96 and an industrial full duplex intercom 95 comprising a microphone and a loudspeaker. The processing unit comprises a transceiver 94 of 2.4 GHz ISM band microwaves which is equipped with an external antenna 93. The processing unit is also linked by TCP/IP to a switch 88 which is in turn linked to the company's security TCP/IP network 89. It is also linked by a cable to a switch 78 which is in turn linked to the company's computer network 79. The segregation of the computer and security TCP/IP networks is the result of a strategic company choice;
a 2.4 GHz ISM band microwave transceiver 92 and an antenna 91 linked by a cable to a switch 87 equipped with bearer current RJ45 ports;
four beacons 21, 22, 23 and 24 equipped with bearer current RJ45 ports each linked by cable to a switch 87 equipped with bearer current RJ45 ports which is in turn linked to the company's security TCP/IP network 89. Each of the four beacons is equipped with a 2.4 GHz ISM band microwave transceiver;
three encapsulated badges 1, 2, and 3, the detail of which is reproduced in the badge 40. In the installation described here, the badges 1, 2 and 3 comprise an energy source 41, a monochrome LED 42, a membrane sound transmitter 43, an actuation member 44 for the LED 42 and the membrane sound transmitter 43, a memory 45, an accelerometer 46 and a 2.4 GHz ISM band microwave transceiver 47;
one badge 30 comprising an energy source, a polychromatic LED (RGB) 31, a membrane sound transmitter 32, an actuation member 33 for the LED 31 and the membrane sound transmitter 32, a memory 34, a 2.4 GHz ISM band microwave transceiver 35 and a low-range transceiver 36 for dialog with the earphone (speaker+microphone) 37 that accompanies the badge.

The function of the transceiver 92 is to replace, as appropriate, the wired link of the company's security TCP/IP network which enables the switches 87 and 88 to correspond. If the cable link were to be cut, the transceiver 92 would dialog with the transceiver 94 of the processing unit 99.

The storage hall comprises seven storage locations numbered from 11 to 17. The storage locations 12 and 15 are free. Three drums of a highly flammable product are arranged in the storage location 17. Each drum 51, 52 and 53 has a respective badge 1, 2 and 3 affixed to it.

An equipped worker has been asked to move the three drums to store them in the location 15. The worker is equipped with the badge 30 and the earphone 37 that accompanies said badge.

Each of the three badges 1, 2 and 3 attached to the drums is on standby because its operating program provides for it to give its position only once a day. Each is, however, equipped with an accelerometer to make it leave its standby mode if the drum to which it is affixed is subjected to a shock or a movement. Leaving the standby mode causes its operating program to restart monitoring the Movements of the drum to which it is affixed.

The worker takes the first drum and deposits it in the location 12 in error. Immediately the drum is deposited, the badge affixed to it starts to blink and to transmit a very rapid beep. The badge has set itself to warning mode and the worker does not understand why. He could call the control room but it is the control room that takes the initiative. In practice, the warning is also signaled on the screen of the operator in the control room. The latter clicks on the line that signals the alarm and designates its type (storage position error) and the screen directly shows him the plan of the storage hall, signaling the badge of the suspect drum in the form of a blinking spot in the location 12. The presence of the worker is also signaled on the plan because he was the human being closest to the badge at the time of the warning. He is signaled, on the plan on the screen, by a pictogram representing the silhouette of a man. While it is he who is signaled on the screen, it is as much for reasons geared towards his protection (he could be wounded) as for reasons based on effectiveness of obtaining information and ensuring that the warning is processed rapidly.

By clicking on the pictogram, a context-sensitive menu is displayed in which one of the possible options is to contact the person by voice because he is equipped for this function. Through his intercom, the operator thus enters into contact with the worker who uses the wireless earphone 37 linked to his badge 30. The operator can thus check with the worker to see that he is not wounded, check that there are no others wounded or any damage and, if not, explain to the worker the error that he has made. Then, by clicking on the blinking spot that represents the drum that has triggered the warning, the operator can directly view the datasheet of the drum but also its storage constraints, data that he can obtain thanks to the link between the processing unit 99 and the company's computer network 79. Furthermore, since this operation was programmed and provided that the management software permits, it may also observe that the requested operation consisted in moving the drums to the location 15. The worker corrects his error by carrying out the maneuver for the drum in the warning condition and, effectively, the badge stops its alarm. The incident can be closed. Should the worker who manipulated the drum not have had audio communication means and the system not have handled the real-time tracking of people in this part of the company, the operator would have been able to send a request to the system to locate the person or people closest to the point of the incident equipped with audio communication means (specific to the embodiment of the invention, or other, such as a portable telephone) in order to contact them.

Thus, by implementing this technology, the operator has been immediately able to have a report of any consequences of the warning and very rapidly implement the solution to correct the error. By applying the invention, it has been possible to avoid a serious risk of fire or explosion, but also a wrong maneuver which could have led to disruptions in the physical management of the stock.

Some technical explanations will provide a better understanding of some of the mechanisms:
Immediately it was woken up again, the badge of the drum was able to locate itself by picking up the signals from the beacons 21 to 24;
The closest worker was able to be designated either because the system, in this point of the factory, provides real time tracking of people, or because the operating program of the badge of the drum has an instruction, in the case of such a warning, to request the processing unit 99 to locate the person closest to it. If the processing unit 99 observes that the real-time tracking of people is not active in this part of the company, it sends, via the switch 88, the security network 89, the switch 87, and, finally, the beacons 21 to 24, a request to the badges worn by people for them to be located and/or give their location: In practice, even if the system does not provide real-time tracking of people, the operating program of the badges continues to compute the location of the badge to provide other functions such as the security functions. The badges therefore regularly listen for the beacons and can therefore receive specific orders transmitted by the processing unit.
The badge of the drum was set to warning mode when it was deposited in the location 12, either because its operating program contains in its memory an authorization restriction for this location, or because the operating program of the badge has queried the processing unit to ascertain whether the location where it is deposited presents no danger and the processing unit has commanded it to set itself to warning mode because the location 12 was not authorized.
Audio location was performed by a link between the earphone 37 of the worker whose signal was relayed by his badge 30, a signal from the badge that was relayed by the beacons 21 to 24 for which the signal was transmitted to the operator's intercom via the switch 87, the security network 89, the switch 88 and finally the processing unit 99.
Once the drum has been replaced in the location 15, the warning is stopped, logged by the processing unit 99 which can, if necessary, communicate it to the company's management computer system. The badge of the suspect drum has once again entered into the standby state until its next scheduled location report or . . . until the next impact or movement.

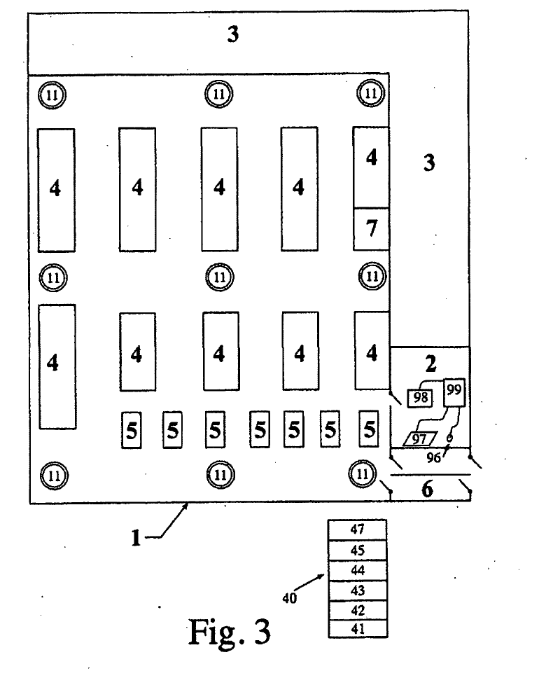

FIG. 3 is a sketch of a hypermarket. The aim of this is to show other noteworthy applications of the invention that are simple to implement but nevertheless effective.

The installation comprises:
a processing unit 99 linked to a display screen 98, a keyboard 97 and a mouse 96. It is linked to each of the beacons by specific cabling (not represented) which enables data transmission but also supplies power to the beacons.
nine beacons 11 that have not been numbered separately because this is not necessary for the explanations of the installation. The beacons are all equipped with a 2.4 GHz ISM band microwave transceiver. This transceiver handles the location functions. Each beacon is linked to the processing unit by specific cabling.
encapsulated badges 40 attached in a non-removable manner but visible (close to the handle) on the carts or baskets used by customers to make their purchases. In the installation described here, the badges comprise an energy source 41, one or more polychromatic (RGB) LEDs 42, a membrane sound transmitter 43, an actuation member 44 for the LED or LEDs 42 and the membrane sound transmitter 43, a memory 45, and a 2.4 GHz ISM band microwave transceiver 47.

The sales area comprises a single-floor building 1 comprising merchandize display departments 4, a management office 2, store areas 3, check-outs 5, an access hall 6 and a predetermined department (or display) 7 that will be the subject of particular attention.

One of the first applications that the invention can bring to bear concerns the marketing surveys that the big stores frequently carry out in their desire for any improvement to the layout of the departments. The installation proposed here makes it possible to automate the collection of data on this subject. In practice, by equipping the carts or baskets for purchases with a badge, the displacement of the latter will be able to be tracked and recorded in real time. By using the statistics that the invention builds up in its processing unit, it will be possible to establish customer behavior profiles.

Furthermore, if necessary, this anonymous survey can be complemented with interviews with certain customers who can be selected, either by observers, or automatically and in real time by the processing unit according to various criteria that will have been established by the people conducting the survey. With this tool, the experts can obviously make advantageous proposals on how to improve the layout of the departments.

Another application concerns promotions. In practice, the invention can enhance the involvement of customers in the promotions, for example by attracting them with gifts, but also by more generally involving all the customers. Take the case of the department 7 that is to be promoted. The customers will be made aware that those who pass through this department and show an interest in it for 30 seconds or longer can take away a superb gift. A draw takes place every half-hour. During the half-hour preceding the draw, the installation will collect the numbers of the badges that have remained for at least 30 seconds in the department. When the half-hour has elapsed, the installation draws up the inventory of the badges of the potential winners and eliminates those who are no longer present (prize draws where no one wins soon lose any credibility). Once this has been done, the draw is announced. At this moment, the LEDs present on the badges of all the store's carts or baskets start to blink in all colors. After a few seconds, a badge is designated by the draw performed by the processing unit and announces, in its own way, that it is the winner by transmitting various sounds and light rays or other devices with which the badges can be equipped. The winner is thus notified publicly and can go to collect his or her gift. In order to avoid bottlenecks in the department being promoted, the installation can be used to change the department around at will. It is thus possible to arrange, on an open day, for all the departments to have been highlighted to the customers. It is also possible to choose the departments according to the opening times by deciding to attract the customers to the departments that are subject to off-peak times at these off-peak moments. This strategy should make it possible to smooth the frequenting of the departments over time and therefore increase their sales potential.

The promotion of the departments as proposed here could perhaps enable the stores to avoid the department organization changes that are performed periodically in order to oblige people to rediscover the store's offerings and not to improve the layout of the departments proper as has been described in the first application.

With an inventive real-time tracking installation as proposed, the number of games or sales drives that can be envisioned to promote a product, a department, a store, is limited only by the imagination of the marketing people, without demanding an enormous cost since almost everything can be managed automatically by the processing unit.

At the technical level, it can be added that certain active beacons could be replaced by passive beacons. In practice, the badge can in any case continue to send its location information in real time to the processing unit by using the active beacons spread around the sales floor.

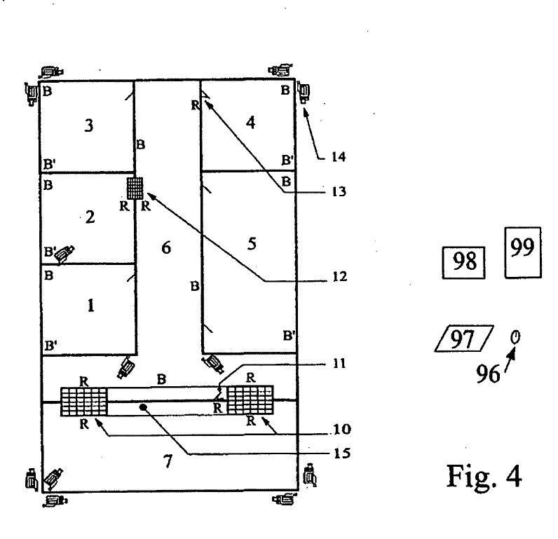

FIG. 4 shows an exemplary installation in the ground floor of a building subject to high surveillance. The objective of this is to describe a new form of installation but also the way in which an inventive installation can collaborate with the conventional security systems.

The installation comprises:
A processing unit 99 linked to a display screen 98, a keyboard 97 and a mouse 96. In this type of installation, it can assumed that the processing unit will be incorporated in the means available to the security control room, including the connections both to the elements that are part of the inventive installation (the beacons, for example) and other peripheral devices and security systems used in the building (access airlocks, electric door opening, video surveillance cameras, RFID readers, etc.).
Beacons (B) each equipped with a 2.4 GHz ISM band microwave transceiver and linked to the processing unit by cabling, the type of link is unimportant (TCP/IP with or without bearer current, specific or other cabling).
Possibly redundant beacons (B′) provided to fulfill a two-fold objective, namely, on the one hand, to take the place, if necessary, of a defective beacon (B) and, on the other hand, to ensure better location accuracy.
Badges 30, not represented in the interests of simplifying the figure, intended for employees comprising an energy source, three polychromatic (RGB) LEDs 31, 32 and 33, a membrane sound transmitter 34, an actuation member 35 for the LEDs 31 to 33 and the membrane sound transmitter 34, a memory 36, a 2.4 GHz ISM band microwave transceiver 37, if technically necessary, a low-range transceiver intended for reading the RFIDs worn by members of staff and, for some, an option comprising a low-range transceiver 38 for dialoging with an earphone (speaker+microphone) 39 that would accompany the badge.
Badges 40 intended for the visitors, identical to the badges 30 except that they support an RFID which serves as an object coupled to the badge.
Two airlocks (10) intended for systematically controlling all members of staff and allowing entry or exit access to just one person at a time. These airlocks are provided with two RFID readers (R) for identifying the person (biometric iris reading has not been chosen in this particular case). They are also equipped with a badge rack.
One airlock (12) intended for personally checking people who want to enter or exit room 2. This airlock also uses two RFID readers (R) to identify people.
The building, its surroundings and, exceptionally, the room 2, are covered by a video surveillance system represented by a certain number of cameras (14) in the figure.
Access to the room 4 is defended by a door with electric door opener (13), the opening of which is controlled by an RFID reader (R) (the choice could have been made to have the door open by means of the badge).
Visitor access is controlled by a door with electric opener (11), the opening of which is controlled by an RFID reader (R).

The building comprises an entry hall 7 that is freely accessed, a room 1 that is freely accessed but where only a few people are allowed to enter, a room 2 placed under high surveillance whose access is defended by an airlock (12) equipped with RFID readers (R), a room 3 that is freely accessed, a room 4, entry to which is controlled by a door provided with an electric opener (13) controlled by an RFID reader (R) and, finally, a room 5 and a corridor 6 that are freely accessed.

The entry of a member of staff takes place as follows: he or she is identified by the reading of a personal RFID and can thus enter alone into one of the access airlocks (10). In the access airlock, there is a rack in which the badges 30 are arranged. The rack has a number of functions: it recharges the badge batteries, when a badge is deposited by a member of staff who is leaving, it renders the latter's badge unusable by transferring to it an operating program that automatically sets the badge to the warning state if it is taken out of the rack and, finally, for a member of staff who is entering, it transfers to the memory of one of the badges in the rack, the operating program intended for that person. The badge is not chosen by chance: in practice, the processing unit that controls and supervises the rack can establish, by the person's statistics and/or descriptive data, a provisional timetable for the person. The processing unit will then take a badge whose battery is sufficiently charged for the badge to be operational for at least as long as the person is present inside the building. Once the operating program has finished transferring to the selected badge, the badge operating program will cause the badge concerned to blink so that the person can take it from the rack and attach it in a visible manner. A few moments after the person has taken the badge, the system opens the door of the airlock that provides access to the building. Obviously, there is a procedure that, if the person leaves his badge in the airlock, provides for the latter to be immediately disabled and for an alarm to be transmitted directly, the airlock remaining locked until the security team has cleared the alarm.

Regarding the exit of a member of staff, this takes place in exactly the reverse manner: the person is identified with his RFID to cause the door of the airlock to open providing access to the secured area. Having entered (alone), the door closes again and the person deposits his or her badge in a free position in the rack. When the rack, ordered by the processing unit, has transferred into the memory of the badge the operating program that immediately sets it to the warning state if it is taken out of the rack, the exit door of the airlock opens and the person can exit.

This procedure therefore guarantees that any member of staff is equipped with his or her badge inside the building and cannot leave with his or her badge. It also makes it impossible for a member of staff to usurp the rights of another member of staff (unless the system is misled by the RFID but, at this level, the biometric reading or the implementation of the RFID can eliminate this risk).

When it comes to the greeting of a visitor arriving at reception (15), the latter declares the reason for his or her visit and the identification of the person he or she is visiting. The person enters this data into the system which will thus be able to establish the security parameters (and therefore the operating program) of the visitor's badge. These parameters comprise, among other things, the places where the visitor can go alone, the places where the visitor can go with such and such an accompanying person, hazardous places (whether they are allowed access or not), and so on. Once the processing unit has transferred the operating program to one of the badges in the reception rack, the badge emits a blink for the person responsible for reception to be able to identify it and hand it to the visitor who must wear it visibly. Once this has been done, the visitor access door (11) is opened and the visitor can enter the building. One small detail to flag is that the LED 31 of the badge of a visitor will emit a color that identifies him or her as a visitor. If necessary, if the visitor requests it, the badge can guide the visitor to the person that he or she is visiting by using the earphone that reception will attach to the badge. The loan of this accessory will be recorded in the system so that it can be recovered when the visitor leaves.

The procedure that records the leaving of a visitor is similar to that which records the leaving of an employee except that the visitor leaves via the reception door through which he or she entered.

To consolidate the procedure, the entry hall is the subject of careful surveillance including the video surveillance and the permanent listening by the beacons (B) placed therein to detect any badges present in the entry hall.

Obviously, the security of the building and the protection of the people present therein could be further reinforced by implementing other means such as biometric recognition, the wearing of underclothing containing the RFID or any other method for improving the link between the member of staff and the RFID that identifies said member of staff uniquely.

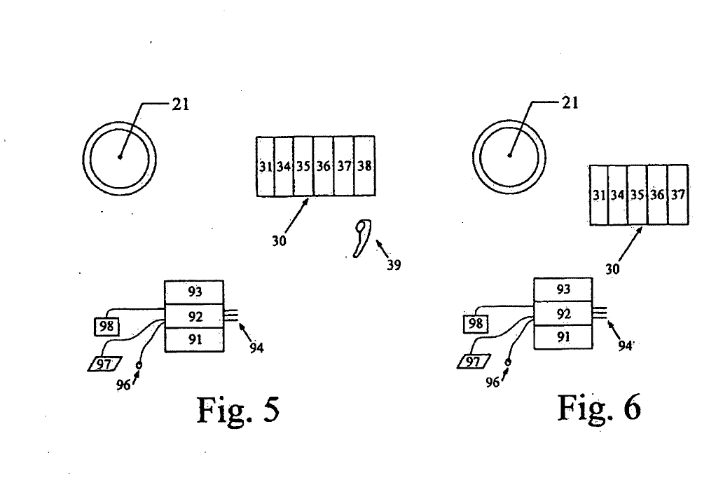

FIG. 5 is a block diagram of an installation intended to provide services to improve and secure site visits. The explanation will be limited to a brief description of two services that the exemplary installation described can provide:
Surveillance of the groups on visits conducted by a guide and a simultaneous human translation service for the remarks made by the guide;
Guidance, by speech in the sites.

The installation comprises:
a processing unit 99 comprising a programming unit 91, an interface 92 provided with a transceiver 93 of microwaves in the 2.4 GHz ISM (Industry, Science and Medical, the frequency bands that can be used freely for industrial, scientific and medical applications) band and physical links 94 with certain beacons. It is linked to a display screen 98, a keyboard 97 and a mouse 96;
beacons (21) each equipped with a 2.4 GHz ISM band microwave transmitter. Some can be connected physically to the interface 92 of the processing unit 99 by a physical link 94 which handles data transmission but also power feed for the beacons (the beacons are connected by star topology). Others can provide the link with the processing unit 99 by microwave means. The power supply for the beacons that are not physically linked to the processing unit can be autonomous or provided by the mains electric circuit of the place which, in certain noncritical cases, can be used as bearer network for linking the beacons to the processing unit which must, in this case, be equipped with a device that connects it to the mains electric network to use it as the bearer network.
Badges 30 comprising an energy source, a monochrome or polychromatic (RGB) LED 31, a membrane sound transmitter (34), an actuation member 35 for the LED 31 and for the membrane sound transmitter 34, a memory 36, a 2.4 GHz ISM band microwave transceiver 37 and, for some, an option consisting of a low-range transceiver 38 for dialoging with an earphone (speaker+microphone) 39 that accompanies the badge.

The principle of the implementation of the surveillance service is fairly simple. When they enter the place they are visiting, the visitors' badges are assigned a beacon (which will be the badge of the guide) from which they must not move away by more than a fixed distance. The guide's badge, by acting as a mobile beacon, enables the badges of the visitors to compute their position relative to the guide. If a visitor lags behind or moves away from the group, his or her badge sets itself to the warning state. A softer surveillance mode can be chosen by triggering warnings whose degree of severity increases according to the distance of the visitor from the guide. For example, the sound warning is transmitted by the offending visitor's badge at a frequency that becomes all the greater as said visitor moves away from the guide. When the badge reaches the limit distance, it sets itself to serious warning state and transmits the maximum light and sound effects. If allowed for in its operating program, it can also have the guide alerted. For this, it will send a request to the processing unit 99 which will send to the guide's badge an order to transmit a fixed effect that will alert the guide. The guide could also be alerted by an audio message synthesized by the processing unit and sent to the speaker of the guide's earpiece provided that the badge is equipped with said earpiece. If necessary, it is possible to envisage asking the processing unit to lead the guide to the visitor who has triggered the warning. For this, the processing unit will use synthesized or prerecorded audio messages. While the guide is absent, the processing unit will also and automatically transfer the role of mobile beacon that the guide's badge was handling to a badge of one of the visitors in the group. In this way, the group remains under control. Immediately the processing unit has observed that the guide has rejoined the group, the processing unit will once again use the guide's badge as the mobile beacon. This mobile beacon substitution function is a noteworthy subtlety of the installation. It is possible because it is the processing unit that gives the order to the badge to transmit its signal as a beacon.

If the guide's badge and the visitors' badges are equipped with an earpiece and, if, on entry, each visitor declares the language in which he wants to hear the explanations from the guide, the system can organize a simultaneous translation of the guide's explanations that will be provided via the links that the badges have with the beacons and the beacons have with the processing unit and the processing unit has with the translators' booths. In practice, the relationship between the badge of each visitor and the badge of the guide is known, the relationship between the language desired by the visitor and the visitor is known, so all that remains is to establish the relationship between the translation booth for the language and the guide. This service is not specific to the invention but is made possible by the elements that make up the installation.

Automatic and interactive audio guidance of the visitors of a site demands more preparation. In practice, the relationship between the position or an area on the site and the audio commentary to be transmitted has to be established. The commentary itself can be provided in at least two ways, either by having it transmitted by the processing unit, but this solution presents the drawback of heavily overloading the links within the installation, or equipping the badge with a music player (for example, a liquid music player) that contains all the commentaries. The advantage that the installation has over similar systems based on RFIDs glued to the objects or in the premises is that it enables the badge of each visitor to be located at any point of the site being visited and therefore to enrich the commentaries. It does, however, have a major advantage in that, in addition to this guidance function, it can provide services oriented towards the protection of the visitors, the security of the premises and accident prevention, for example, by it being able to notify the visitors of hazardous places or places that can be visited only with an accompanying person or even by signaling visitors who are in prohibited locations.

FIG. 6 is a block diagram of an installation in the maintenance field. It offers noteworthy functions for the mobile equipment that can be ideal for fixed equipment. The installation will be able to handle the following functions in real time:
Locating mobile equipment;
Ascertaining the status of the mobile equipment;
Reserving mobile equipment;
Having data relating to the usage of the equipment;
Signaling in a simple way, to the user, the equipment that has failed or needing maintenance.

The installation comprises the following elements:
a processing unit 99 comprising a programming unit 91, an interface 92 provided with a receiver 93 of microwaves in the 2.4 GHz ISM (Industry, Science and Medical, the frequency bands that can be used freely for industrial, scientific and medical applications) band and physical links 94 with certain beacons. It is linked to a display screen 98, a keyboard 97 and a mouse 96 and also comprises a link (not represented in the interests of simplifying the figure) with the computer system of the structure that uses the installation (hospital, factory, etc.);
beacons (21) each equipped with a 2.4 GHz ISM band microwave transmitter. Some can be physically connected to the interface 92 of the processing unit 99 by a physical link 94 which handles data transmission but also supplies power to the beacons (beacons connected by star topology). Others can provide the link with the processing unit 99 by microwave means. The power supply for the beacons that are not physically linked to the processing unit can be autonomous or provided by the mains electricity circuit in the place.
badges 30 comprising an energy source, a monochrome or polychromatic (RGB) LED 31, a membrane sound transmitter 34, an actuation member 35 for the LED 31 and the membrane sound transmitter 34, a memory 36, a 2.4 GHz ISM band microwave transceiver 37.

An encapsulated badge is either fixed to the equipment that is to be tracked or incorporated therein. The location is based on the very principle, of the invention and need not be commented on further. By a request made to the processing unit, it is possible to obtain, for example, all the equipment handling a particular function or corresponding to a predetermined parts list code.

If the encapsulated badge linked to the equipment is provided with one or more sensors that make it possible to determine whether the equipment is being used and what it is doing, it will also be possible to ascertain which equipment is not being used.

If required, a reservation function can, for example, be activated by asking the encapsulated badge to activate a light source, the color and the blinking frequency of which correspond to an organization code stating that it is reserved.

The encapsulated badge which is provided with sensors can collect the data from the sensors, memorize the data and also send it to the processing unit 99. It will thus be possible to establish statistics relating to the use of the equipment. By exploiting this feature, it will also be possible to detect, for the target equipment, whether their maintenance has been carried out provided that this type of operation is managed and tracked by computer. In the case where the equipment is not properly maintained, it is possible to ask the encapsulated badge to which it is linked to transmit a sound and/or light signal that will notify the user that he or she must no longer make use of this equipment. If the incorporation of the encapsulated badge in the equipment is thorough enough, it can even prevent the equipment from being used. This function is important in that it can avoid accidents or serious errors, for example, for lifting equipment, medical or laboratory appliances or, in general, any equipment whose malfunction places lives in peril.

1. A surveillance installation, comprising:
a plurality of badges capable of displacement, each of said badges provided with at least one energy radiation source and an actuation member for said source, provided with a memory;
at least one actuation member programming unit; and
an interface between the programming unit and the actuation member memory, for transferring an operating program from said programming unit to said actuation member memory,
said interface comprising
at least one beacon;
at least one sender of energy waves to the beacon; and
at least one receiver of said energy waves, supported by each badge; and
the abovementioned actuation member of each badge and its memory being driven by
a space position of said badge relative to the beacon, said space position being calculated at any instant by the operating program in response to messages sent by the beacon,
characterized in that at least one of the badges is multipurpose and capable of handling the beacon role.

2. The installation as claimed in claim 1, characterized in that at least one of the multipurpose badges handles the beacon role.

3. The installation as claimed in claim 1, characterized in that the beacon and/or the beacon of the multipurpose badge comprises a clock which is capable of pacing a transmission of said energy waves by the transmitter.

4. The installation as claimed in claim 1, characterized in that the actuation member and the memory are driven in response to instructions transmitted by the beacon.

5. The installation as claimed in claim 4, characterized in that the instructions comprise instructions relating to the space coordinates of the badges capable of displacement.

6. The installation as claimed in claim 5, characterized in that the programming unit includes a program containing a spatialization table comprising parameters relating to the space coordinates of the badges.

7. The installation as claimed in claim 6, characterized in that the actuation member and the memory are driven in response to instructions transmitted by the beacon and relate to the topography of the environment of the badges.

8. The installation as claimed in claim 7, characterized in that the programming unit includes a program containing a topography table comprising parameters relating to the topography of the environment of the badges capable of displacement.

9. The installation as claimed in claim 8, characterized in that each badge capable of displacement comprises an energy wave transmitter and the beacon comprises a receiver of said energy waves and in that the actuation member for each badge capable of displacement is driven by information transferred from the transmitter of said badge to the receiver of the beacon.

10. The installation as claimed in claim 9, characterized in that it further comprises a processing unit for information collected from the badge and/or from the beacon.

11. The installation as claimed in claim 10, characterized in that the processing unit is adapted to memorize data, perform mathematical and/or logical operations.

12. The installation as claimed in claim 11, characterized in that the processing unit is designed to give the multipurpose badge the instruction to handle the beacon function.

13. The installation as claimed in claim 12, further comprising at least one second beacon equipped with a transmitter and a receiver of the energy waves, the two beacons being linked in a network.

14. The installation as claimed in claim 13, characterized in that the network is of the type with collisions.

15. The installation as claimed in claim 13, characterized in that the network is of the type with scanning.

16. The installation as claimed in claim 15, characterized in that at least one of the badges capable of displacement comprises a second memory, the function of which is to memorize the space position of said badge relative to at least one of the beacons, said second memory being designed to be read by the interface.

17. The installation as claimed in claim 16, characterized in that at least one of the beacons comprises a pulse counter, adapted to send energy signals from the transmitter of the beacon to the receiver of each badge capable of displacement, at predetermined time intervals.

18. The installation as claimed in claim 17, characterized in that at least one of the programming unit and the beacons is capable of displacement.

19. The installation as claimed in claim 18, characterized in that the link by energy waves between the receiver of at least one badge capable of displacement and the transmitter of the beacon passes through at least one relay equipped with an energy wave transceiver.

20. The installation as claimed in claim 19, characterized in that at least one badge supports at least one motion detector and/or at least one sensor of a physical or chemical or physiological parameter.

21. The installation as claimed in claim 20, characterized in that, in the case where a badge comprises a second memory, the the second memory is adapted to memorize the quantities of parameters measured by the detector, respectively the sensor.

22. The installation as claimed in claim 21, characterized in that at least one badge is coupled to an object identifying the wearer of said badge.

23. The installation as claimed in claim 22, characterized in that it comprises at least one first badge capable of displacement provided with an energy wave receiver and at least one second badge capable of displacement that is provided with a receiver and a transmitter of energy waves and in that the actuation member of the first badge capable of displacement is driven by information transferred from the transmitter of the second badge to the receiver of the first badge.

24. The installation as claimed in claim 23, characterized in that the energy radiation source for at least one of the badges capable of displacement comprises an acoustic or electromagnetic radiation source and in that the actuation member is designed to act on the activation, the frequency and/or the intensity of the radiation.

25. The installation as claimed in claim 24, characterized in that the energy radiation source is a light source.

26. The installation as claimed in claim 25, characterized in that at least one of the badges comprises a microphone and/or a sound diffuser and/or an image reader and/or an image transmitter.

27. The installation as claimed in claim 26, characterized in that at least one badge is joined to a beacon.

28. The installation as claimed in claim 27, characterized in that the badges are adapted to be worn by people and/or animals and/or objects that are fixed or capable of displacement.

29. The installation as claimed in claim 28, further comprising a device provided with an artificial intelligence designed to react to a signal transmitted by the energy radiation source of the badges.

30. The installation as claimed in claim 29, adapted for the surveillance of rooms of a building.
